(19) United States
(12) Patent Application Publication
(10) Pub. No.: US 2015/0312360 A1
(43) Pub. Date: Oct. 29, 2015

(54) DETERMINING ANONYMOUSLY IDENTIFIED USERS IN MESSAGE CONTENT

(71) Applicant: International Business Machines Corporation, Armonk, NY (US)

(72) Inventors: Piyush Agarwal, Billerica, MA (US); James J. Antill, Howth (IE); Vincent Burckhardt, Clonee (IE); Bernadette A. Carter, Raleigh, NC (US)

(73) Assignee: International Business Machines Corporation, Armonk, NY (US)

(21) Appl. No.: 14/260,842

(22) Filed: Apr. 24, 2014

(51) Int. Cl. H04L 29/08; H04L 29/06

(52) U.S. Cl. CPC H04L 67/24; H04L 65/403; H04L 67/306

(57) ABSTRACT

A computer detects an entry of content by a first user in a collaboration application and determines the entry of content contains an identification of a second user, the identification indicating the entry of content and the identification are to be visible only to the first user and the second user. Responsive to determining the entry of content contains the identification of a second user, the computer copies the entry of content. The computer then sends the copied entry of content to the second user in the collaboration application.

### FIELD OF THE INVENTION

The present invention relates generally to the field of electronic messaging communication and collaboration, and more particularly to determining if a message identifies users anonymously for private sharing of the message content.

### BACKGROUND OF THE INVENTION

A significant amount of communication occurs through the use of electronic messaging and communication systems, such as email systems, text messaging systems, instant messaging systems, and social networking platforms. As electronic messaging and communication systems have gained popularity, specifically within social networking platforms, new features have been identified, such as the ability to share information with other users. Along with the new features, inefficiencies have been identified, such as the ability to share information with other users privately. In collaboration based social networking applications, a user is capable of notifying another user of specific content by mentioning the user in the shared content, while the content itself and any associated comment thread remains visible to anyone reading the message.

### SUMMARY

Embodiments of the present invention disclose a method, computer program product, and computer system for determining an entry of content identifies users for private sharing of the content. The method includes detecting, by one or more computer processors, an entry of content by a first user in a collaboration application and determining the entry of content contains an identification of a second user, the identification indicating the entry of content and the identification are to be visible only to the first user and the second user. Responsive to determining the entry of content contains the identification of a second user, the method includes copying, by one or more computer processors, the entry of content. The method then includes sending, by one or more computer processors, the copied entry of content to the second user in the collaboration application.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 is a flowchart depicting operational steps of a message identifier program, for determining a message is to be shared with an anonymously identified user, and copying the message to the anonymously identified user, in accordance with an embodiment of the present invention.

FIG. 3 illustrates exemplary user interfaces for operation of the message identifier program of FIG. 2, in accordance with an embodiment of the present invention.

FIG. 4 depicts a block diagram of components of the client computing device of FIG. 1, in accordance with an embodiment of the present invention.

### DETAILED DESCRIPTION

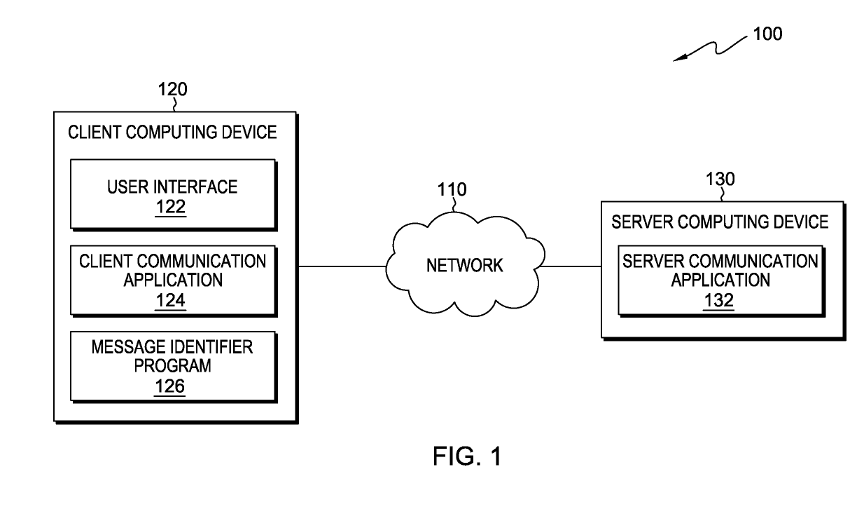

The present invention will now be described in detail with reference to the Figures. FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes client computing device 120 and server computing device 130, interconnected via network 110. Network 110 can be, for example, a local area network (LAN), a telecommunications network, a wide area network (WAN), such as the Internet, a virtual local area network (VLAN), or any combination of the four, and can include wired, wireless, or fiber optic connections. In general, network 110 can be any combination of connections and protocols that will support communications between client computing device 120 and server computing device 130, in accordance with embodiments of the present invention.

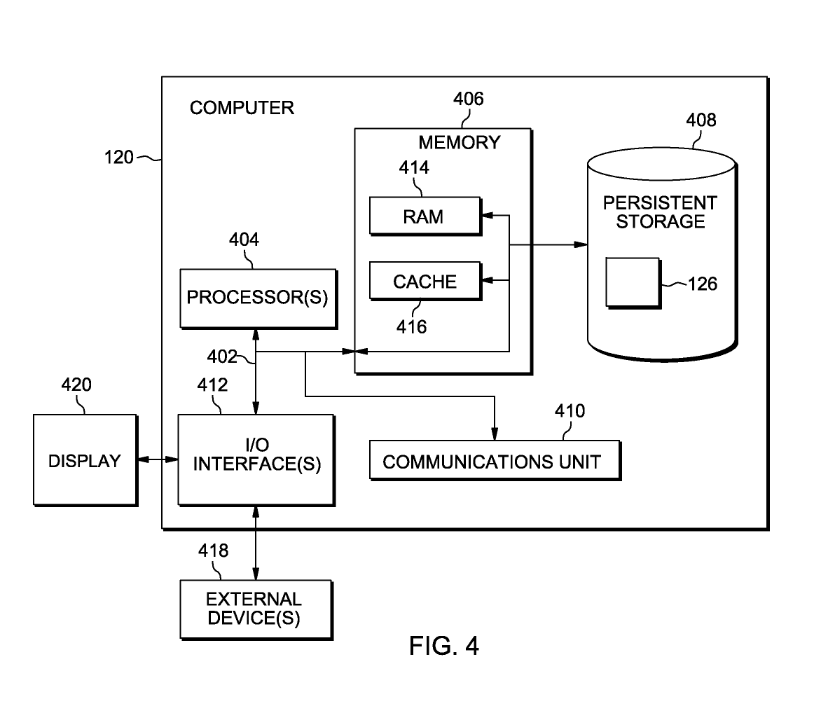

In various embodiments of the present invention, client computing device 120 may be a desktop computer, a workstation, a laptop computer, a tablet computer, a personal computer (PC), a personal digital assistant (PDA), a smart phone, or any programmable electronic device or a combination of electronic devices capable of executing machine readable program instructions and of communicating with server computing device 130 via network 110 and with various components and devices within distributed data processing environment 100. Client computing device 120 includes user interface (UI) 122, client communication application 124, and message identifier program 126. While in FIG. 1, message identifier program 126 is depicted on client computing device 120, one of skill in the art will recognize that message identifier program 126 may be located elsewhere within distributed data processing environment 100. Client computing device 120 may include internal and external hardware components, as depicted and described with reference to FIG. 4.

UI 122 may be, for example, a graphical user interface (GUI) or a web user interface (WUI), and can display text, documents, web browser windows, instant message applications, user options, instructions for operation, and other application interfaces. A user interface, such as UI 122, refers to the information (such as graphics, text, and sound) an application presents to a user and the control sequences the user employs to control the application. There are many types of user interfaces. In one embodiment, UI 122 is a graphical user interface. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. The actions in GUIs are often performed through direct manipulation of the graphical elements. In one embodiment, UI 122 is the interface between client computing device 120 and message identifier program 126.

Client communication application 124 is software capable of retrieving and presenting information obtained from the World Wide Web. In an embodiment of the present invention, a user operating client computing device 120 can view and interact with a webpage (e.g., post a message) or other information stored on a computer system, such as server computing device 130. In various embodiments of the present invention, client communication application 124 is a collaboration-based application or other social networking platform where a user can share a microblog, a blog, images or videos, or any other exchange between users of small elements of content.

Message identifier program 126 detects an author is entering content, for example, creating a message, to post via client communication application 124 within distributed data processing environment 100 and parses the message to determine whether the author has anonymously mentioned or identified a user in the message. If so, message identifier program 126 creates a copy of the created original message which is then shared only between the author and the anonymously identified user. The author may anonymously identify several users with which to share the message, and message identifier program 126 determines whether the users are included in a same group, or the users are identified individually. In an embodiment, the author can mention multiple users while typing text in the message, and identify the users for anonymous sharing or for public sharing. Message identifier program 126 creates separate copies of the original message for each group or individual anonymously identified.

Server computing device 130 may be a management server, a web server, or any other electronic device or computing system capable of receiving and sending data. In other embodiments, server computing device 130 may represent a server computing system utilizing multiple computers as a server system, such as in a cloud computing environment. In another embodiment, server computing device 130 may be a laptop computer, a tablet computer, a netbook computer, a PC, a desktop computer, a PDA, a smart phone, or any programmable electronic device capable of communicating with client computing device 120 via network 110. In another embodiment, server computing device 130 represents a computing system utilizing clustered computers and components (e.g., database server computer, application server computers, etc.) that act as a single pool of seamless resources when accessed within distributed data processing system 100.

Server computing device 130 includes server communication application 132. Server communication application 132 is an application that can provide information accessed by client communication application 124, for example, information stored on server computing device 130 or information accessible via network 110, or can transmit information sent by client communication application 124 to other components and devices within distributed data processing environment 100. In an embodiment of the present invention, message identifier program 126 transmits a copied message to users anonymously identified by the message author via server communication application 132.

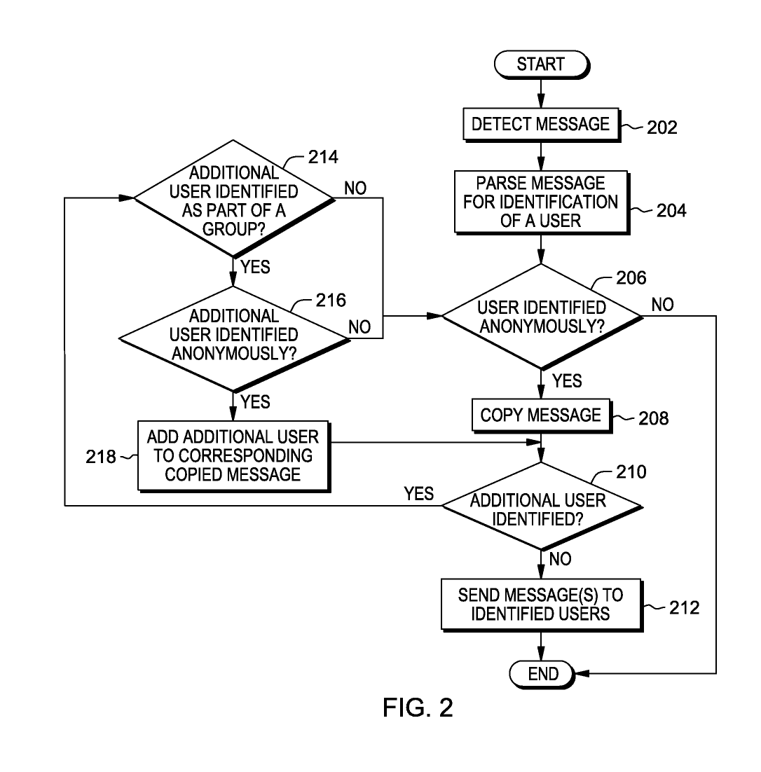

FIG. 2 is a flowchart depicting operational steps of message identifier program 126, for determining a message is to be shared with an anonymously identified user, and copying the message to the anonymously identified user, in accordance with an embodiment of the present invention.

Message identifier program 126 detects a message (step 202). A message, or some other entry of content, is created by a user, such as an author, on a collaboration application or a social networking application, such as client communication application 124. The author creates the message with content to share, which can include original content or copied content from another source. The message content may include text, graphics, video, web links, or images.

Message identifier program 126 parses the message for an identification of a user (step 204). In an embodiment, message identifier program 126 parses the message for mentions of a user embedded in the message content. In embodiments, the author can share the message publicly, or the author may indicate a specific user with which to share the message content. Message identifier program 126 can use known textual analysis methods to determine whether a message identifies a user by use of a user name or other identifying information, such as a screen name or avatar.

Message identifier program 126 determines whether the message anonymously identifies a user (decision block 206). In embodiments of the present invention, a user can be identified anonymously in a message by specific pre-defined characters embedded in the message content in addition to the user's name, for example, an author may type “+” or “anon@”, followed by a name, a user name, or other identifying information. In other embodiments, the identification can be a social networking mention of the user with some other indication included with text of the mention that the identification is anonymous, such as a text symbol or character. An anonymous identification of a user indicates the message is to be visible to the author and the identified user. If the user is not identified anonymously (decision block 206, “no” branch), message identifier program 126 ends processing. If the user is identified anonymously (decision block 206, “yes” branch), message identifier program 126 copies the message (step 208). Message identifier program 126 creates a copy of the original message, including content of the message and the anonymously identified user name. In an embodiment, the original message remains and the anonymously identified users are not visible to the public. The copy of the original message may contain a link or reference to the publicly visible original message, for example, a web link to a webpage showing the publicly visible original message and its associated comment thread. In an embodiment, message identifier program 126 provides the anonymously identified user with a notification that the user is identified in a message by the author.

Message identifier program 126 determines whether an additional user is identified by the author (decision block 210). If no additional user is identified (decision block 210, “no” branch), message identifier program 126 sends the copied message to the identified user (step 212). In an embodiment, each copy, and any additional content, including corresponding comments and comment threads, is only visible to the author of the original message and the anonymously identified user, creating a private discussion between the author and the identified user. In various embodiments of the present invention, content of the copied message is altered from entered content of the original message to indicate to the anonymously identified user that the content of the copied message is private. The content may be altered, for example, by appearing in italics, in bold print, or in a different color than the entered content of the original message. The original message remains public, and retains a public comment thread visible to anyone allowed to view the original message or microblog. If an additional user is identified (decision block 210, “yes” branch), message identifier program 126 determines whether the additional user is identified as part of a group including another user (decision block 214). In an embodiment, a group of users may be identified anonymously, for example, in a common set of parentheses, such as “(+Joe +Mary)”. If the additional user is identified as part of a group (decision block 214, “yes” branch), message identifier program 126 determines whether the additional user is identified anonymously (decision block 216). If the additional user is identified as part of a group and anonymously (decision block 216, “yes” branch), message identifier program 126 adds the additional user to the corresponding copied message (step 218). Continuing the previous example, “(+Joe +Mary)” creates a copied message visible to the author and to both Joe and Mary.

If message identifier program 126 determines the additional user is not identified as part of a group including another user (decision block 214, “no” branch), the program determines whether the additional user is identified anonymously (decision block 206). If so, processing continues. In an example, an author may identify “(+Sue)(+Jim)”. Message identifier program 126 creates two copies of the original message, and two separate threads, with one visible to the author and Sue, and the other visible to the author and Jim. If the additional user is not identified anonymously, processing ends.

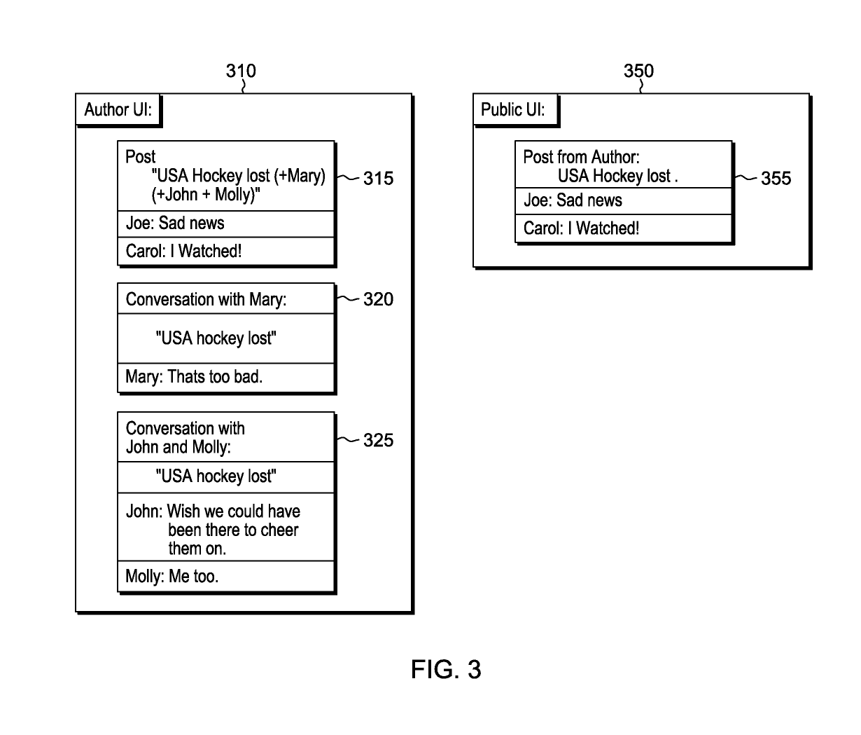

FIG. 3 illustrates exemplary user interfaces corresponding to operation of message identifier program 126, in accordance with an embodiment of the present invention.

Author UI 310 and Public UI 350 depict, respectively, a user interface visible to an author and a user interface visible to a public audience. Author UI 310 includes post 315, conversation 320 and conversation 325, each visible to the author. Public UI 350 includes only posts visible to the public, such as post 355. In the illustrated embodiment, post 315 depicts a message posted by the author, along with two anonymous identifications, one sharing the message with “Mary” and one sharing the message with both “John” and “Molly”. As shown in conversation 320, message identifier program 126 creates a copy of the original message post visible to the author and to “Mary”, along with any comments on the copied message post. Conversation 325 depicts a copy of the original message created by message identifier program 126 visible to the author and to both “John” and “Molly”. Post 355 on public UI 350 shows message content visible to the public only, which includes the message content and the related comment thread.

FIG. 4 depicts a block diagram of components of a computer, for example, client computing device 120, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Client computing device 120 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Message identifier program 126 is stored in persistent storage 408 for execution by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including server computing device 130. In these examples, communications unit 410 includes one or more network interface cards. Communications unit 410 may provide communications through the use of either or both physical and wireless communications links. Message identifier program 126 may be downloaded to persistent storage 408 through communications unit 410.

I/O interface(s) 412 allows for input and output of data with other devices that may be connected to client computing device 120. For example, I/O interface(s) 412 may provide a connection to external device(s) 418 such as a keyboard, a keypad, a touch screen, and/or some other suitable input device. External device(s) 418 can also include portable computer-readable storage media such as, for example, thumb drives, portable optical or magnetic disks, and memory cards. Software and data used to practice embodiments of the present invention, e.g., message identifier program 126, can be stored on such portable computer-readable storage media and can be loaded onto persistent storage 408 via I/O interface(s) 412. I/O interface(s) 412 also connect to a display 420. Display 420 provides a mechanism to display data to a user and may be, for example, a computer monitor or an incorporated display screen, such as is used in tablet computers and smart phones.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for determining anonymously identified users in an entry of content, the method comprising:
detecting, by one or more computer processors, an entry of content by a first user in a collaboration application;
determining, by one or more computer processors, the entry of content contains an identification of a second user, the identification indicating the entry of content and the identification are to be visible only to the first user and the second user;
responsive to determining the entry of content contains the identification of a second user, copying, by one or more computer processors, the entry of content; and
sending, by one or more computer processors, the copied entry of content to the second user in the collaboration application.

2. The method of claim 1, further comprising:
determining, by one or more computer processors, the entry of content contains a second identification of an additional user, wherein the second identification indicates the entry of content and the identification are to be visible to the first user and the additional user;
copying, by one or more computer processors, the entry of content; and
sending, by one or more computer processors, the copied entry of content to the additional user.

3. The method of claim 1, further comprising:
determining, by one or more computer processors, the entry of content contains an identification of a plurality of users, wherein the identification indicates the entry of content and the identification are to be visible to the first user and the plurality of users;
copying, by one or more computer processors, the entry of content; and
sending, by one or more computer processors, the copied entry of content to the plurality of users.

4. The method of claim 1, wherein determining, by one or more computer processors, the entry of content contains an identification of a second user, the identification indicating the entry of content and the identification is to be visible to the first user and the second user further comprises determining, by one or more computer processors, the entry of content includes at least a pre-defined character indicating the entry of content is to be visible to the first user and the second user and a user name identifying the second user.

5. The method of claim 1, wherein copying, by one or more computer processors, the entry of content further comprises:
determining, by one or more computer processors, an original content of the entry of content;
determining, by one or more computer processors, additional content associated with the entry of content; and
copying, by one or more computer processors, the original content, the additional content, and the identification of the second user.

6. The method of claim 1, wherein the entry of content by the first user in the collaboration application is visible to the first user and one or more other users of the collaboration application and the identification and the copied entry of content are visible to the first user and the second user.

7. The method of claim 1, wherein the entry of content includes one or more of: text, graphics, video, web links, and images.

8. A computer program product for determining anonymously identified users in an entry of content, the computer program product comprising:
one or more computer readable storage media and program instructions stored on the one or more computer readable storage media, the program instructions comprising:
program instructions to detect an entry of content by a first user in a collaboration application;
program instructions to determine the entry of content contains an identification of a second user, the identification indicating the entry of content and the identification are to be visible only to the first user and the second user;
responsive to determining the entry of content contains the identification of a second user, program instructions to copy the entry of content; and
program instructions to send the copied entry of content to the second user in the collaboration application.

9. The computer program product of claim 8, further comprising:
program instructions to determine the entry of content contains a second identification of an additional user, wherein the second identification indicates the entry of content and the identification are to be visible to the first user and the additional user;
program instructions to copy the entry of content; and
program instructions to send the copied entry of content to the additional user.

10. The computer program product of claim 8, further comprising:
program instructions to determine the entry of content contains an identification of a plurality of users, wherein the identification indicates the entry of content and the identification are to be visible to the first user and the plurality of users;
program instructions to copy the entry of content; and
program instructions to send the copied entry of content to the plurality of users.

11. The computer program product of claim 8, wherein the program instructions to determine the entry of content contains an identification of a second user, the identification indicating the entry of content and the identification are to be visible to the first user and the second user further comprises program instructions to determine the entry of content includes at least a pre-defined character indicating the entry of content is to be visible to the first user and the second user and a user name identifying the second user.

12. The computer program product of claim 8, wherein program instructions to copy the entry of content further comprise:
program instructions to determine an original content of the entry of content;
program instructions to determine additional content associated with the entry of content; and
program instructions to copy the original content, the additional content, and the identification of the second user.

13. The computer program product of claim 8, wherein the entry of content by the first user in the collaboration application is visible to the first user and one or more other users of the collaboration application and the identification and the copied entry of content are visible to the first user and the second user.

14. The computer program product of claim 8, wherein the entry of content includes one or more of: text, graphics, video, web links, and images.

15. A computer system for determining anonymously identified users in an entry of content, the computer system comprising:
one or more computer processors;
one or more computer readable storage media;
program instructions stored on the one or more computer readable storage media for execution by at least one of the one or more computer processors, the program instructions comprising:
program instructions to detect an entry of content by a first user in a collaboration application;
program instructions to determine the entry of content contains an identification of a second user, the identification indicating the entry of content and the identification are to be visible only to the first user and the second user;
responsive to determining the entry of content contains the identification of a second user, program instructions to copy the entry of content; and
program instructions to send the copied entry of content to the second user in the collaboration application.

16. The computer system of claim 15, further comprising:
program instructions to determine the entry of content contains a second identification of an additional user, wherein the second identification indicates the entry of content and the identification are to be visible to the first user and the additional user;
program instructions to copy the entry of content; and
program instructions to send the copied entry of content to the additional user.

17. The computer system of claim 15, further comprising:
program instructions to determine the entry of content contains an identification of a plurality of users, wherein the identification indicates the entry of content and the identification are to be visible to the first user and the plurality of users;
program instructions to copy the entry of content; and
program instructions to send the copied entry of content to the plurality of users.

18. The computer system of claim 15, wherein the program instructions to determine the entry of content contains an identification of a second user, the identification indicating the entry of content and the identification are to be visible to the first user and the second user further comprises program instructions to determine the entry of content includes at least a pre-defined character indicating the entry of content is to be visible to the first user and the second user and a user name identifying the second user.

19. The computer system of claim 15, wherein program instructions to copy the entry of content further comprise:
program instructions to determine an original content of the entry of content;
program instructions to determine additional content associated with the entry of content; and
program instructions to copy the original content, the additional content, and the identification of the second user.

20. The computer system of claim 15, wherein the entry of content by the first user in the collaboration application is visible to the first user and one or more other users of the collaboration application and the identification and the copied entry of content are visible to the first user and the second user.
